(19) United States
(12) Patent Application Publication
(10) Pub. No.: US 2024/0177230 A1
(43) Pub. Date: May 30, 2024

(54) PERIOD SETTING SYSTEM, PERIOD SETTING METHOD, AND PERIOD SETTING PROGRAM

(71) Applicant: Isuzu Motors Limited, Yokohama-shi (JP)

(72) Inventors: Shinya OZAKI, Yokohama-shi (JP); Keisuke KIMURA, Yokohama-shi (JP)

(73) Assignee: Isuzu Motors Limited, Yokohama-shi (JP)

(21) Appl. No.: 18/520,598

(22) Filed: Nov. 28, 2023

(30) Foreign Application Priority Data
Nov. 29, 2022 (JP) 2022-190154

(51) Int. Cl. G06Q 30/0645; B60L 58/16

(52) U.S. Cl. CPC G06Q 30/0645; B60L 58/16

(57) ABSTRACT

A period setting system of the present disclosure is capable of setting an appropriate lease period for an electric vehicle according to the user's operation plan. The period setting system is for setting a lease period of an electric vehicle and includes the following: an acquisition section that acquires user information including a user's operation plan for the electric vehicle; a storage section that stores deterioration information indicating the relationship between the user information and a deterioration degree of a battery that is used for a travel of the electric vehicle and installed in the electric vehicle; a calculation section that calculates a specific period specified for setting a lease period based on the user information and the deterioration information; and an output section that outputs the specific period.

### TECHNICAL FIELD

The present disclosure relates to a period setting system, a period setting method, and a period setting program.

### BACKGROUND ART

As a method of providing commercial vehicles, in addition to selling a vehicle to a user, a method that is referred to as a lease is available. In a lease, a vehicle is lent to a user under lease conditions in which the lease period or travel distance and the associated costs are set. In the case of a full maintenance lease agreement, the leasing cost is set from the amount of money obtained as follows: dividing, by the contract period, the total amount of money obtained by adding to the vehicle price maintenance costs including parts replacement that may occur based on the travel distance of the vehicle by the user. In recent years, the use of electric vehicles (EVs) that are driven by using electric power stored in batteries has been expanding.

Patent Literature (hereinafter, referred to as PTL) 1, for example, describes a battery capacity notification device that notifies the state of deterioration of a battery based on traveling information of an electric vehicle (EV) and the number of times the battery has been charged (herein also referred to as “number of charging times”).

### CITATION LIST

### Patent Literature

PTL 1
Japanese Patent Application Laid-Open No. 2015-031588

### SUMMARY OF INVENTION

### Technical Problem

When a lease period is set for an electric vehicle (EV) in the same manner as for a conventional diesel vehicle, the battery deterioration may progress at the end of the lease period, and in some cases, the vehicle fails to travel the user's desired travel distance. Specifically, for example, when the lease period is 5 years and the annual travel distance for an electric vehicle is 100,000 km, the battery deterioration may progress to such an extent that the vehicle cannot travel the desired distance in a single operation by the end of the lease period. In contrast, when the annual travel distance is short, the battery may have a surplus capacity even after the lease period has expired.

Depending on the operation plan of a user (herein also referred to as “user's operation plan”) which includes the annual travel distance, there are cases where the battery deterioration progresses, and cases where the battery deterioration does not progress at all. Therefore, when the deterioration state of a battery (how the battery would deteriorate) can be predicted at the time of setting the lease period, it becomes possible to set an appropriate lease period.

The battery capacity notification device described in PTL 1 does not predict the deterioration state of the battery. Therefore, even when this battery capacity notification device is used at the time of setting the lease period, it is difficult to set an appropriate lease period according to the user's operation plan for the electric vehicle.

An object of the present disclosure to provide a period setting system, a period setting method, and a period setting program each capable of setting an appropriate lease period for an electric vehicle according to the user's operation plan.

### Solution to Problem

For achieving the above object, a period setting system in the present disclosure is as follows:

A period setting system for setting a lease period of an electric vehicle, the system including:
an acquisition section that acquires user information including a user's operation plan for the electric vehicle;
a storage section that stores deterioration information indicating a relationship between the user information and a deterioration degree of a battery that is used for a travel of the electric vehicle and installed in the electric vehicle;
a calculation section that calculates a specific period specified for setting the lease period based on the user information and the deterioration information; and
an output section that outputs the specific period.

A period setting method in the present disclosure is as follows:

A period setting method for setting a lease period of an electric vehicle, the method including:
acquiring user information including a user's operation plan for the electric vehicle;
acquiring a specific period specified for setting the lease period based on deterioration information and the user information, in which the deterioration information indicates a relationship between the user information and a deterioration degree of a battery that is used for a travel of the electric vehicle and installed in the electric vehicle; and
outputting the specific period.

A period setting program in the present disclosure is as follows:

A period setting program for setting a lease period of an electric vehicle, the program causing a computer to execute processing including:
acquiring user information including a user's operation plan for the electric vehicle;
acquiring a specific period specified for setting the lease period based on deterioration information and the user information, in which the deterioration information indicates a relationship between the user information and a deterioration degree of a battery that is used for a travel of the electric vehicle and installed in the electric vehicle; and
outputting the specific period.

### Advantageous Effects of Invention

The present disclosure can set an appropriate lease period for an electric vehicle according to the user's operation plan.

### BRIEF DESCRIPTION OF DRAWINGS

FIG. 1 is a block diagram schematically illustrating the functional configuration of a period setting system in an embodiment of the present disclosure;

FIG. 2 illustrates an exemplary relationship between SOH and a number of years that have passed;

FIG. 3 illustrates an example of deterioration characteristics depending on the charging mode of a battery;

FIG. 4 illustrates an exemplary relationship between SOH and a travelable distance;

FIG. 5 illustrates the travelable distance per operation based on the user A's operation plan;

FIG. 6 illustrates the travelable distance per operation based on the user B's operation plan;

FIG. 7 illustrates an exemplary processing for calculating a specific period in the present embodiment; and

FIG. 8 illustrates a comparison of the travelable distance between the case where the power consumption of equipment is low and the case where the power consumption of equipment is large.

### DESCRIPTION OF EMBODIMENT

Hereinafter, at least one embodiment of the present disclosure will be described with reference to the drawings.

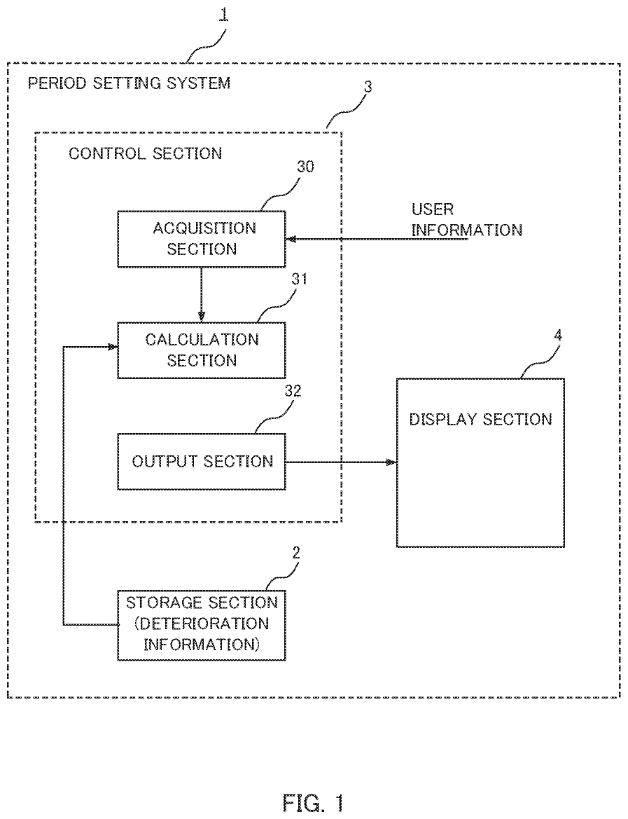

FIG. 1 is a block diagram schematically illustrating the functional configuration of a period setting system in an embodiment of the present disclosure. The period setting system in the present embodiment is applied for setting a lease period for a leased vehicle. In the present embodiment, a leased vehicle is an electric vehicle (EV), which is driven by using electric power stored in a battery.

The configuration of period setting system 1 can be achieved by using a computer, a digital device built into a computer, and the peripherals thereof, for example, information device such as a personal computer, a smartphone, a tablet terminal, a display (monitor), a printer, a server computer, and network equipment. Period setting system 1 has a function of calculating a specific period for setting a lease period based on information on a user who uses a leased vehicle and information on deterioration of a battery installed in the leased vehicle (battery deterioration information: described below).

Period setting system 1 includes storage section 2, control section 3, and display section 4 as functional blocks. In FIG. 1, arrows indicate main data flows, and there may be data flows that are not illustrated in FIG. 1. In FIG. 1, each functional block indicates the configuration of a functional unit, not the configuration of a hardware (device) unit. Therefore, the functional blocks illustrated in FIG. 1 may be implemented within a single device, or may be implemented separately within a plurality of devices. Data may be exchanged between the functional blocks via any means such as a data bus or a controller area network (CAN) bus.

Storage section 2 is a storage device including the following: a read only memory (ROM) storing, for example, the basic input output system (BIOS) of a computer that achieves the configuration of period setting system 1; a random access memory (RAM) serving as work areas for period setting system 1; a hard disk drive (HDD) storing an operating system (OS), application programs, various information referenced when executing the application programs, and battery deterioration information; and a solid state drive (SSD).

Control section 3 is a processor including a central processing unit (CPU) and a graphics processing unit (GPU) of period setting system 1. Control section 3 functions as acquisition section 30, calculation section 31, and output section 32 as the control section executes programs stored in storage section 2.

FIG. 1 illustrates an example in which period setting system 1 is configured with a single device. However, the configuration of period setting system 1 may be achieved from, for example, calculation resources such as a plurality of processors and memories. In this case, the configuration of each section constituting control section 3 is achieved by the execution of a program by at least one of the plurality of different processors.

### Acquisition Section 30 and User Information

Acquisition section 30 acquires user information including a user's operation plan for an electric vehicle (EV). User information is input, for example, by using an input device such as a keyboard, a mouse, or a touch panel. The operation plan includes, for example, the number of running days, the number of operations per day, and the travel distance per operation in each of the first year, second year, . . . , Nth year (N is a natural number). From this operation plan, the user's travel distance per year for each year can be determined. The operation plan also includes the traveling region (such as cold region and warm region) in which the EV will travel. Furthermore, the operation plan includes the season (such as cold season and warm season) in which the EV will travel. The operation plan also includes the roads (such as expressways and general roads) on which the EV will travel.

### Battery Deterioration Information

The battery deterioration information includes one or more functions (deterioration functions) indicating the relationship between the user information and the deterioration degree of a battery (herein also referred to as “battery deterioration degree”), or one or more tables indicating the relationship between the user information and the battery deterioration degree. A deterioration function and a table are determined in advance by experiments and/or simulations. State of health (SOH) is one of the indicators representing the health level and deterioration state of a battery. A SOH can be represented as the ratio of the full charge capacity when a battery has deteriorated to the full charge capacity at the initial stage of the battery. In other words, the full charge capacity when a battery has deteriorated is represented by a multiplication value obtained by multiplying the full charge capacity at the initial stage by the SOH.

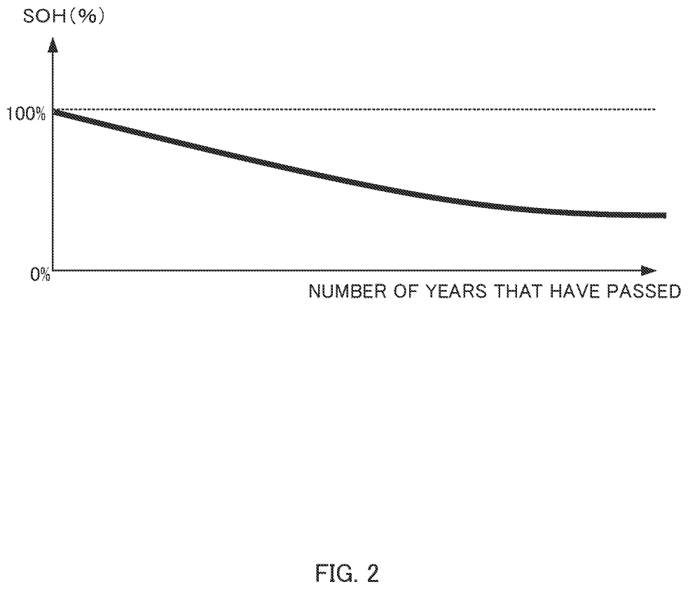

The battery deterioration degree includes the battery deterioration degree depending on time. For example, the SOH decreases depending on time. FIG. 2 illustrates an exemplary relationship between SOH and a number of years that have passed. In FIG. 2, the horizontal axis indicates the number of years that have passed from the initial stage, and the vertical axis indicates the SOH (%). As shown in FIG. 2, the SOH decreases according to the number of years that have passed. The SOH at the beginning of the first year is set to 100%.

In addition, the battery deterioration degree includes the battery deterioration degree depending on the number of charging cycles. The number of charging cycles is a value obtained by dividing the amount of charge and discharge (kWh) by the full charging capacity (kWh). The number of charging cycles per year is a value obtained by dividing the amount of charge and discharge (kWh) per year by the amount of full charge (kWh). Therefore, the SOH decreases according to the number of charging cycles. The charging cycle is a parameter corresponding to the amount of charge and discharge of a battery, and is different from the actual number of charging times. For example, it is assumed that after a battery is charged to full charge, and charged electricity is used to about half, the battery is charged to full charge. In this case, the number of charging times is one, but the amount of charge and discharge is half of the full charge, so the number of charging cycles is 0.5.

Moreover, the battery deterioration degree includes the battery deterioration degree related to the electricity cost of the electric vehicle (EV). Electricity costs are worse in cold regions than in warm regions. In addition, electricity costs are worse in the cold season than in the warm season. Electricity costs are worse on general roads than on expressways. Electricity costs are estimated based on the operation plan of the traveling region and the like.

The battery deterioration degree includes the battery deterioration degree depending on the charging mode of the battery. The battery deteriorates more when the charging mode is fast charging than when the charging mode is normal charging.

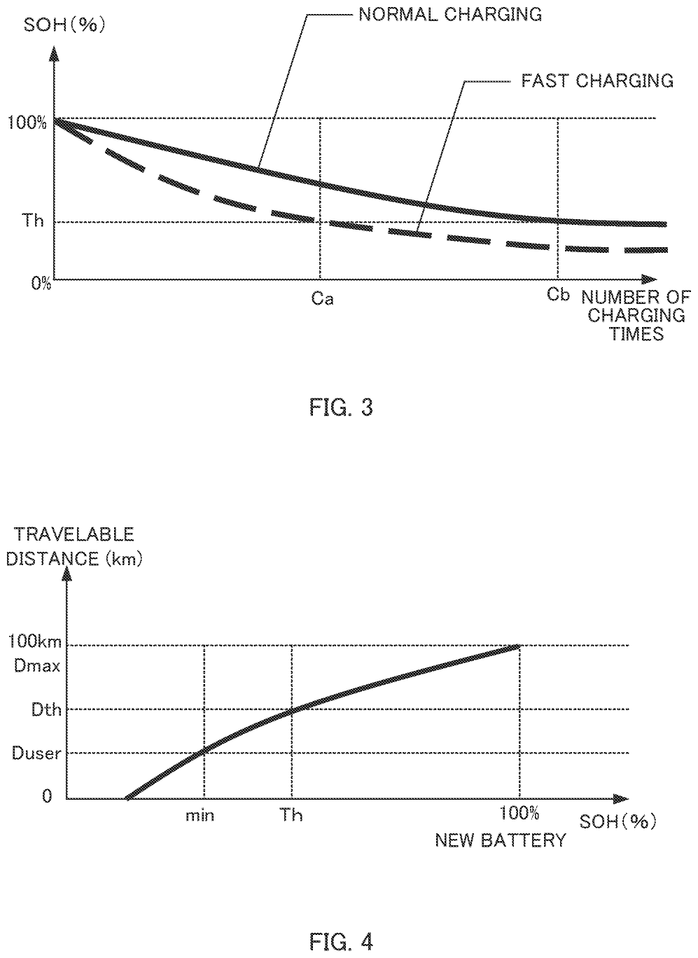

With reference to FIG. 3, battery deterioration depending on the charging mode of a battery will be described. FIG. 3 illustrates an example of deterioration characteristics depending on the charging mode of a battery. In FIG. 3, the horizontal axis indicates the number of charging times, and the vertical axis indicates the SOH. In FIG. 3, a solid line indicates the SOH when the charging mode is normal charging, and a dashed line indicates the SOH when the charging mode is fast charging. “Th” in FIG. 3 is the remaining rate of the SOH and serves as a guideline for ending the lease. The remaining rate is higher than the SOH that allows the user to travel the user's travel distance in one operation. In addition, “Ca” is the number of charging times at which the SOH decreases to Th (%) when fast charging is repeated. “Cb” is the number of charging times at which the SOH decreases to Th (%) when normal charging is repeated. As shown in FIG. 3, the degree of decrease in SOH is higher when fast charging is repeated than when normal charging is repeated (deterioration characteristics). By acquiring the charging type to be used (normal charging or fast charging) as user information and switching the deterioration characteristics according to the charging type, it is possible to calculate SOH more accurately. As described above, SOH decreases depending on the charging mode.

### Calculation Section 31

Calculation section 31 calculates a specific period specified for setting a lease period for the electric vehicle based on the user information and the deterioration information. Calculation section 31 can also serve as an acquisition section that acquires a specific period specified for setting a lease period for the electric vehicle based on the user information and the deterioration information. A deterioration function or a table is used as the deterioration information. The specific period may be the same as the lease period, or may be a period referred to for setting the lease period. In the present embodiment, the specific period is set to be the same as the lease period and is indicated as a specific period (lease period).

For example, whether or not the Nth year is included in the lease period is determined with reference to the specific period calculated based on user information and deterioration information from the first year to the Nth year. In the following, an example of calculating a specific period (lease period) will be described. As the user information, the number of running days, the number of operations per day, and the travel distance per operation are used.

Calculation section 31 calculates the user's travel distance per year in the Nth year based on the user information. Furthermore, calculation section 31 estimates the electricity cost at the beginning of the Nth year. Calculation section 31 further calculates the amount of charge and discharge (kWh) per year in the Nth year by dividing the user's travel distance per year in the Nth year by the electricity cost. Calculation section 31 calculates the number of charging cycles per year in the Nth year by dividing the amount of charge and discharge (kWh) per year in the Nth year by the maximum charge amount at the time when the battery is new, and multiplying the divided value by the SOH at the beginning of the Nth year. Furthermore, calculation section 31 calculates the SOH at the beginning of the (N+1)th year based on the number of charging cycles per year in the Nth year and the number of years that have passed. As described above, a travelable distance per operation, which is the distance allowing one operation of the electric vehicle when the battery is fully charged, in the Nth year is obtained.

Calculation section 31 further compares the travelable distance per operation in the Nth year with the user's travel distance per operation in the Nth year. For example, when the travelable distance per operation in the Nth year is longer than the user's travel distance per operation in the Nth year, the Nth year can be incorporated into the lease period. That is, the first to Nth years constitute the specific period (lease period). On the other hand, when the travelable distance per operation in the Nth year is shorter than the user's travel distance per operation in the Nth year, the Nth year cannot be incorporated into the lease period. In this case, for example, when the travelable distance per operation in (N−1)th year is longer than the user's travel distance per operation in (N−1)th year, the first to (N−1)th year constitute the specific period (lease period).

### Output Section 32

Output section 32 outputs a specific period. In the present embodiment, output section 32 outputs the specific period (lease period) to display section 4.

In the following, the relationship between SOH and a travelable distance will be described with reference to FIG. 4. FIG. 4 illustrates an exemplary relationship between SOH and a travelable distance. In FIG. 4, the horizontal axis indicates the SOH, and the vertical axis indicates the travelable distance (km). The travelable distance in FIG. 4 is a travelable distance when a battery is fully charged. In FIG. 4, a dotted line indicates a user's travel distance Duser per day, and a dashed line indicates a threshold value Dth, obtained by adding a predetermined margin to the user's travel distance per day. The predetermined margin is set from the viewpoint of safety margin in operation.

As illustrated in FIG. 4, the SOH when the battery is new is set to 100%. The travelable distance when the SOH is 100% is set to 100 km. A solid line indicates the relationship between the SOH and the travelable distance. The SOH indicated by the intersection of the solid line and the user's travel distance Duser per day is a minimum value min. When the SOH is less than the minimum value min, the operation of the EV becomes difficult from the viewpoint of battery deterioration characteristics. The SOH indicated by the intersection of the solid line and the threshold value Dth is a threshold value Th of the SOH. When the SOH is less than the threshold value Th, the operation of the EV becomes difficult from the viewpoint of safety margin in operation. On the other hand, when the SOH is equal to or greater than the threshold value Th, operation of the EV is possible. The specific period (lease period) during which the operation of the EV is possible is defined as a period during which the travelable distance can be maintained at a value equal to or more than the threshold value Th. For setting lease conditions, the leasing cost can be set without battery replacement costs taken into account for a period shorter than the specific period. When the period exceeds the specific period, the leasing cost can be set with battery replacement costs taken into account. Thus, it is possible to propose to a user lease conditions with an appropriate period and cost structure according to the user's needs.

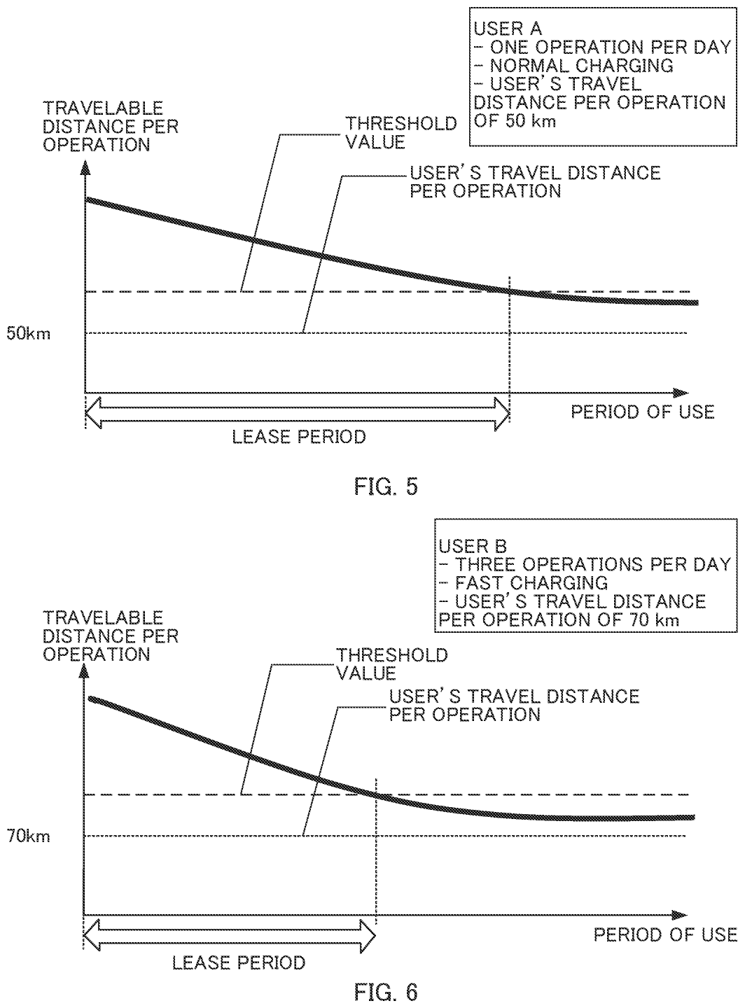

FIG. 5 illustrates the travelable distance per operation based on the user A's operation plan. In FIG. 5, the horizontal axis indicates the period of use, and the vertical axis indicates the travelable distance per operation. A solid line indicates the relationship between the travelable distance per operation and the period of use (period during which the battery can be used).

The user A's operation plan includes “one operation per day,” “normal charging,” and “user's travel distance per operation of 50 km.” In FIG. 5, a dotted line indicates the user's travel distance per operation. A dashed line indicates a threshold value obtained by adding a predetermined margin to the user's travel distance per operation. The margin is set from the viewpoint of safety margin in operation. The period of use indicated by the intersection of the solid line and the threshold value in FIG. 5 can be set as the lease period.

FIG. 6 illustrates the travelable distance per operation based on the user B's operation plan. In FIG. 6, the horizontal axis indicates the period of use, and the vertical axis indicates the travelable distance per operation. A solid line indicates the relationship between the travelable distance per operation and the period of use (period during which the battery can be used).

The user B's operation plan includes “three operations per day,” “fast charging,” and “user's travel distance per operation of 70 km.” In FIG. 6, a dotted line indicates the user's travel distance per operation. A dashed line indicates a threshold value obtained by adding a predetermined margin to the user's travel distance per operation. The period of use indicated by the intersection of the solid line and the threshold value in FIG. 6 can be set as the lease period.

As can be seen from FIGS. 5 and 6, the user A's operation plan has reduced deterioration of the battery as compared to the user B's operation plan; therefore, it is possible to set a longer lease period for the user A's operation plan than the user B's operation plan.

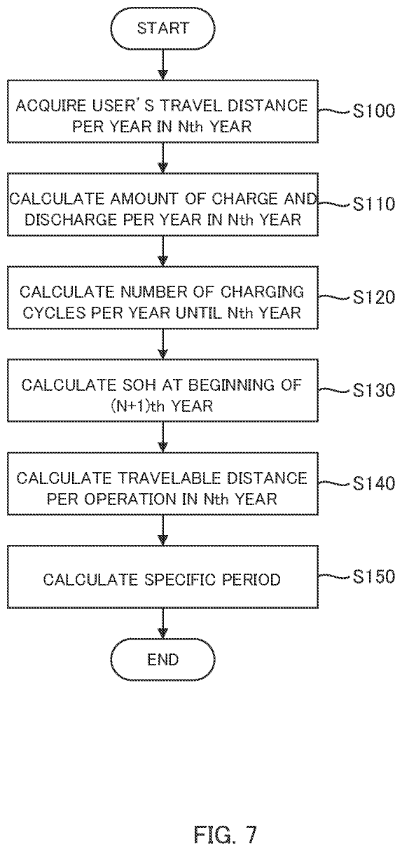

In the following, an exemplary processing for calculating a specific period in the present embodiment will be described with reference to FIG. 7. FIG. 7 is a flowchart illustrating an exemplary processing for calculating a specific period in the present embodiment. The flow is started by inputting user information including the user's operation plan. The storage section stores battery deterioration information. The processing shown in the flow is executed by each function of control section 3 of period setting system 1; however, in this description, it is assumed that a CPU executes the processing. In addition, a case will be described in which whether or not the Nth year is included in the lease period is determined based on the calculation result of the specific period. The SOH when the battery is new is set to 100%.

First, in step S100, the CPU acquires the user's travel distance per year in the Nth year.

Next, in step S110, the CPU calculates the amount of charge and discharge per year in the Nth year by dividing the user's travel distance per year in the Nth year by the electricity cost.

Next, in step S120, the CPU calculates the number of charging cycles per year in each year until the Nth year as follows: dividing the amount of charge and discharge per year in each year until the Nth year by the maximum charge amount at the time when the battery is new, and multiplying the divided value by the SOH at the beginning of the corresponding year.

Next, in step S130, the CPU calculates the SOH at the beginning of the (N+1)th year based on the number of charging cycles until the Nth year and the number of years that have passed (N years).

Next, in step S140, the CPU calculates the travelable distance per operation in the Nth year.

Next, in step S150, the CPU calculates the specific period based on the travelable distance per operation in the Nth year and the user's travel distance per operation in the Nth year. Specifically, the CPU sets the specific period (lease period) as follows: when the travelable distance per operation in the Nth year is longer than the user's travel distance per operation in the Nth year, the specific period (lease period) is set to be until the Nth year; and when the travelable distance per operation in the Nth year is shorter than the user's travel distance per operation in the Nth year and the travelable distance per operation in the (N−1)th year is longer than the user travel distance per operation in the (N−1)th year, the specific period (lease period) is set to be until the (N−1)th year.

Period setting system 1 in the above embodiment is a period setting system for setting a lease period of an electric vehicle (EV). The period setting system includes the following: acquisition section 30 that acquires user information including a user's operation plan for the electric vehicle; storage section 2 that stores deterioration information indicating the relationship between the user information and a deterioration degree of a battery that is used for a travel of the electric vehicle and installed in the electric vehicle; calculation section 31 that calculates a specific period specified for setting a lease period based on the user information and the deterioration information; and output section 32 that outputs the specific period.

The above configuration is capable of outputting a specific period calculated based on user information and deterioration information, and setting a lease period based on the output specific period. Therefore, it becomes possible to set an appropriate lease period according to the user's operation plan for an electric vehicle.

In period setting system 1 in the above embodiment, calculation section 31 calculates the travelable distance per operation, which is the distance allowing one operation of the electric vehicle when the battery is fully charged, and calculates a specific period based on the calculated travelable distance per operation. As a result, the specific period can be accurately calculated.

In period setting system 1 in the above embodiment, the operation plan includes the user's travel distance per operation, and calculation section 31 calculates the specific period based on the result of comparison between the travelable distance per operation and the user's travel distance per operation. As a result, when the travelable distance per operation in the Nth year is longer than the user's travel distance per operation in the Nth year, the specific period is set to be until the Nth year. Therefore, an appropriate lease period can be provided to the user based on the specific period in a simple manner.

In period setting system 1 in the above embodiment, the battery deterioration degree may include the battery deterioration degree related to equipment (object mounted on a vehicle and electrical component) provided in the electric vehicle. In the following description, objects that deteriorate a battery due to the running thereof, such as objects mounted on a vehicle and electrical components, may be collectively referred to as “equipment.” The battery deteriorates due to the equipment running. As a result, even when there is a remaining battery charge, travel may become almost impossible.

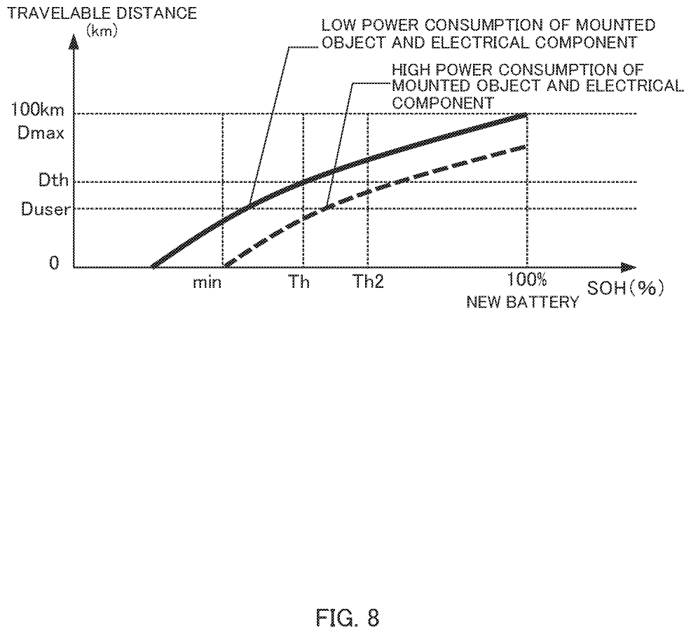

A case where the battery deterioration degree includes the battery deterioration degree related to equipment will be described with reference to FIG. 8. FIG. 8 illustrates a comparison on the travelable distance between the case where the power consumption of equipment is low and the case where the power consumption of equipment is high. In FIG. 8, the horizontal axis indicates the SOH (%), and the vertical axis indicates the travelable distance (km). In FIG. 8, a solid line indicates the relationship between the travelable distance and the SOH in the case where the power consumption of equipment is low, and a dashed line indicates the relationship between the travelable distance and the SOH in the case where the power consumption of equipment is high. The travelable distance is the travelable distance when the battery is fully charged.

As shown in FIG. 8, for the same SOH, the travelable distance in the case where the power consumption of equipment is high is shorter than the travelable distance in the case where the power consumption of equipment is low. In other words, for the same travelable distance, the SOH required in the case where the power consumption of the equipment is high is larger than the SOH required in the case where the power consumption of the equipment is low. A threshold value Th of the SOH indicated by the intersection of a user's travel distance Dth per day and the travelable distance in the case where the power consumption of equipment is low is smaller than a threshold value Th2 of the SOH indicated by the intersection of the user's travel distance Dth per day and the travelable distance in the case where the power consumption of equipment is high.

For example, when the equipment is only a luggage compartment without an air conditioning function, the power consumption of the equipment is low because the utilization rate of the air conditioner is low. On the other hand, when the equipment is, for example, a mounted object with a refrigeration function, power consumption is high. The relationship between the SOH and the travelable distance varies depending on the type of equipment of a leased vehicle (for example, a refrigerator or garbage collection apparatus). The power consumed during running of the equipment varies depending on the type of equipment, the travelable distance of a vehicle is determined from the electric power minus the electric power for running the equipment. In the present embodiment, the user information includes information indicating the type of equipment and the travel environment (average temperature or temperature difference), and period setting system 1 may switch the characteristic data of the travelable distance for the SOH based on the user information.

The embodiments above are no more than specific examples in carrying out the present disclosure, and the technical scope of the present disclosure is not to be construed in a limitative sense due to the specific examples. That is, the present invention can be carried out in various forms without departing from the spirit and the main features thereof.

This application claims priority based on Japanese Patent Application No. 2022-190154, filed on Nov. 29, 2022, the entire contents thereof are incorporated herein by reference.

### INDUSTRIAL APPLICABILITY

The present disclosure is suitably used in information device equipped with a period setting system that is required to set an appropriate lease period according to a user's operation plan for an electric vehicle.

### REFERENCE SIGNS LIST

1 Period setting system
2 Storage section
3 Control section
30 Acquisition section
31 Calculation section
32 Output section
4 Display section

1. A period setting system for setting a lease period of an electric vehicle, the system comprising:
an acquisition section that acquires user information including a user's operation plan for the electric vehicle;
a storage section that stores deterioration information indicating a relationship between the user information and a deterioration degree of a battery that is used for a travel of the electric vehicle and installed in the electric vehicle;
a calculation section that calculates a specific period specified for setting the lease period based on the user information and the deterioration information; and
an output section that outputs the specific period.

2. The period setting system according to claim 1, wherein
the deterioration degree of the battery includes a deterioration degree of the battery with respect to an amount of charge and discharge of the battery.

3. The period setting system according to claim 1, wherein
the deterioration degree of the battery includes a deterioration degree of the battery related to an electricity cost of the electric vehicle.

4. The period setting system according to claim 1, wherein
the deterioration degree of the battery includes a deterioration degree of the battery depending on time.

5. The period setting system according to claim 1, wherein
the deterioration degree of the battery includes a deterioration degree of the battery related to a charging mode of the battery.

6. The period setting system according to claim 1, wherein
the deterioration degree of the battery includes a deterioration degree of the battery related to equipment provided in the electric vehicle.

7. The period setting system according to claim 1, wherein
the calculation section calculates a travelable distance per operation and calculates the specific period based on the travelable distance per operation calculated, the travelable distance per operation being a distance that allows one operation of the electric vehicle when the battery is fully charged.

8. The period setting system according to claim 7, wherein
the operation plan includes a user's travel distance per operation; and
the calculation section calculates the specific period based on a result of a comparison between the travelable distance per operation and the user's travel distance per operation.

9. A period setting method for setting a lease period of an electric vehicle, the method comprising:
acquiring user information including a user's operation plan for the electric vehicle;
acquiring a specific period specified for setting the lease period based on deterioration information and the user information, wherein the deterioration information indicates a relationship between the user information and a deterioration degree of a battery that is used for a travel of the electric vehicle and installed in the electric vehicle; and
outputting the specific period.

10. A period setting program for setting a lease period of an electric vehicle, the program causing a computer to execute processing comprising:
acquiring user information including a user's operation plan for the electric vehicle;
acquiring a specific period specified for setting the lease period based on deterioration information and the user information, wherein the deterioration information indicates a relationship between the user information and a deterioration degree of a battery that is used for a travel of the electric vehicle and installed in the electric vehicle; and
outputting the specific period.
